(19) United States
(12) Patent Application Publication
(10) Pub. No.: US 2026/0202967 A1
(43) Pub. Date: Jul. 16, 2026

(54) ENABLING WRITER PROCESS ISOLATION BY DESIGNATING MEMORY BLOCKS AS WRITE-RESERVED

(71) Applicant: Dell Products L.P., Round Rock, TX (US)

(72) Inventors: Jonathan Walton, Seattle, WA (US); Timothy Wright, Portland, OR (US)

(21) Appl. No.: 19/017,347

(22) Filed: Jan. 10, 2025

(51) Int. Cl. G06F 3/06

(52) U.S. Cl. CPC G06F 3/0613; G06F 3/0659; G06F 3/0673

(57) ABSTRACT

The technologies described herein are generally directed to enabling writer process isolation by designating memory blocks as write-reserved. For instance, a system can lock a portion of memory with a first write lock that grants exclusive write access to the memory writing process. The system can further, based on a releasing of the first write lock, designate the portion of memory with a write available designation, as available for acquisition of a second write lock that grants exclusive write access, and unavailable for access by a memory reading process. The system can further, based on a condition being determined to be present, remove the write available designation.

### BACKGROUND

Modern approaches to presenting content may utilize approaches where processes concurrently operate to generate and consume computer system files. In some circumstances, a process may be writing a file, while other processes may be reading from another region of the file.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include, based on a request from a memory writing process, locking, by a system including one or more processors, a portion of memory with a first write lock that grants exclusive write access to the memory writing process. The example method may further include, based on a releasing of the first write lock, designating, by the system, the portion of memory with a write available designation, as available for acquisition of a second write lock that grants exclusive write access, and unavailable for access by a memory reading process. The example method may further include, based on a condition being determined to be present, removing the write available designation.

In additional or alternative embodiments, after the designating of the portion of memory with the write available designation, no writes to the portion of memory occur, and after the removal of the write available designation, the memory reading process reads the portion of memory. In additional or alternative embodiments, the method may further include, based on an estimated speed determined to be applicable to a reading process that sequentially reads the portion of memory that was written by the system, selecting, a buffer value corresponding to usage of a buffer to use for the reading process, and the condition may include the buffer value.

In additional or alternative embodiments, the method may further include, analyzing, by the system, the reading by the memory reading process, based on a result of the analyzing, updating, by the system, the estimated speed of the reading process, resulting in an updated estimated speed, and based on the updated estimated speed, updating, by the system, the buffer value. In additional or alternative embodiments, the buffer value may include a time delay determined by comparing a speed of the memory writing process to the estimated speed of the reading process, and the buffer value was selected based on the estimated speed of the reading process and the speed of the memory writing process. In additional or alternative embodiments, the buffer value may include a period of time after the writing by the memory writing process.

In additional or alternative embodiments, the buffer value may include an amount of memory blocks to remain unavailable for reading after the writing by the memory writing process. In additional or alternative embodiments, the method may further include, based on the designating of the portion of memory as write available, communicating, by the system to the memory reading process, a signal indicating that the memory writing process continues to write to the portion of memory, with the portion of memory being unavailable for access by the memory reading process in response to communicating the signal. In additional or alternative embodiments, the portion of memory is unavailable for access by the memory reading process based on the memory with the write available designation appearing to the memory reading process as memory where exclusive write access has been granted.

In additional or alternative embodiments, the buffer value was selected based on a likelihood that the reading process is going to be in contention with the writing process during the writing of the stream. In additional or alternative embodiments, the contention may include a pausing of the reading process based on the reading process seeking to read a next block after a last block written by the memory writing process. In additional or alternative embodiments, the memory writing process may include a stream writing process that writes a stream to the memory, and the memory reading process reads the stream sequentially. In additional or alternative embodiments, the portion of memory is unavailable for access by the memory reading process based on the memory with the write available designation appearing to the memory reading process as memory at an end of a file.

An example system can operate as follows. At least one memory may store computer executable instructions, and at least one processor may be configured to process the computer executable instructions that, when executed by the at least one processor, facilitate performance of operations. The operations may include writing, at a writing speed, a first memory block of a stream to a first sequential memory block range of a system memory, and concurrent with the writing of the first memory block, a reading process reads the stream from a second sequential memory block range of the system memory trailing the first sequential memory block range. The operations may further include predicting, with threshold likelihood, that an additional memory block will be written, resulting in a prediction. The operations may further include selecting a buffer value, with the buffer value being based on an estimated reading speed of the reading process in the reading of the stream. Further, the operations may include, based on the buffer value and the prediction, applying a write-reserved designation of a buffer block size to a third sequential memory block range between the first sequential memory block range and the second sequential memory block range of the system memory.

In additional or alternative embodiments, the write-reserved designation allows the system to acquire an exclusive write lock to the third sequential memory block range, while preventing any reading of the third sequential memory block range. In additional or alternative embodiments, the write-reserved designation further allows other writing processes to acquire the exclusive write lock, when available. In additional or alternative embodiments, the buffer value was selected to reduce a likelihood that the reading process is going to contend with the writing of the stream. In additional or alternative embodiments, an exclusive write lock was granted to the system for usage with writing to the first sequential memory block range. In additional or alternative embodiments, the operations may further include, after a period of time passes without an exclusive write lock being placed on a block having the write-reserved designation, removing, by the system, the write-reserved designation from the block having the write-reserved designation.

An example non-transitory machine-readable medium may include executable instructions that, when executed by at least one processor, facilitate performance of operations. The operations may include, based on a request associated with a memory writing process, locking first data blocks of a system memory with a first lock that grants exclusive writing capability to the memory writing process. The operations may further include, based on releasing the first lock, predicting that an additional write operation will be performed on second data blocks, resulting in a write prediction. The operations may include, based on the write prediction, designating the second data blocks as being in a write reserved state, and based on the write reserved state, rejecting a first request from a reading process to read the second data blocks, and granting a second request from another memory writing process to acquire a second lock that grants exclusive writing capability to the second data blocks. In additional or alternative embodiments, the operations may further include, after a duration without a write operation performed on the second data blocks, designating the second data blocks as not being in the write reserved state.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate writer process isolation by designating memory blocks as write-reserved, in accordance with one or more embodiments;

FIG. 2 is an architecture diagram of an example system that can facilitate writer process isolation by designating memory blocks as write-reserved, in accordance with one or more embodiments;

FIG. 3 includes a diagram that illustrates aspects of example system that can facilitate writer process isolation by designating memory blocks as write-reserved, in accordance with one or more embodiments;

FIG. 4 includes a diagram that illustrates aspects of example system that can facilitate writer process isolation by designating memory blocks as write-reserved, in accordance with one or more embodiments;

FIG. 5 includes a diagram that illustrates aspects of example system that can facilitate writer process isolation by designating memory blocks as write-reserved, in accordance with one or more embodiments;

FIG. 6 depicts a flow diagram representing example operations of an example method 600 that can facilitate managing system services based on detection of node maintenance events, in accordance with one or more embodiments;

FIG. 7 depicts an example system that can facilitate writer process isolation by designating memory blocks as write-reserved, in accordance with one or more embodiments;

FIG. 8 depicts an example non-transitory machine-readable medium that can include executable instructions that, when executed by a processor of a system, can facilitate writer process isolation by designating memory blocks as write-reserved, in accordance with one or more embodiments;

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

In one or more embodiments, file systems may use read/write locks to serialize operations, allowing multiple threads (e.g., processes, connections, clients) to simultaneously read a file, but only allowing a single writer to exclusively add to/modify the file. Read/write locks can be applied to a subset of a file, such as a specific byte-range, thereby facilitating simultaneous/concurrent reading and writing of a file, by reading processes and a writing process, respectively. A common scenario for this circumstance is a livestream or broadcast recording-and-playback mechanism, where a content-creator is writing to a file, and content-consumers are reading from somewhere earlier in the file.

By utilizing one or more implementations as described herein, the performance, efficiency, and management of systems with concurrent reading and writing processes can be improved, e.g., by providing approaches that may isolate writing processes from reading processes in certain circumstances. Often, locks may be more efficient when uncontended and writes to a file can be more efficient if the writer is allowed to write to the file unhindered, and readers are far enough behind. If the readers are too close to the writer attempts to read from the file can interfere with the writing process, causing the writes to fall behind real-time, and effectively fail. One or more embodiments described herein are not abstract concepts; rather, they provide technical solutions to technical problems associated with concurrent reading and writing processes in computer systems, providing technical solutions to technical problems that are inextricably tied to computer systems. For example, generally speaking, one or more embodiments may reduce the likelihood of writing process inefficiencies by designating memory blocks as write-reserved, e.g., a temporary unlocked state in which a lock on the memory blocks may only be acquired by a writing process. Moreover, implementations described herein can provide these solutions in a manner that cannot reliably be performed by a human or even a plurality of humans, e.g., solutions provided are integral to the operating system and storage controller functions of a computer system.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

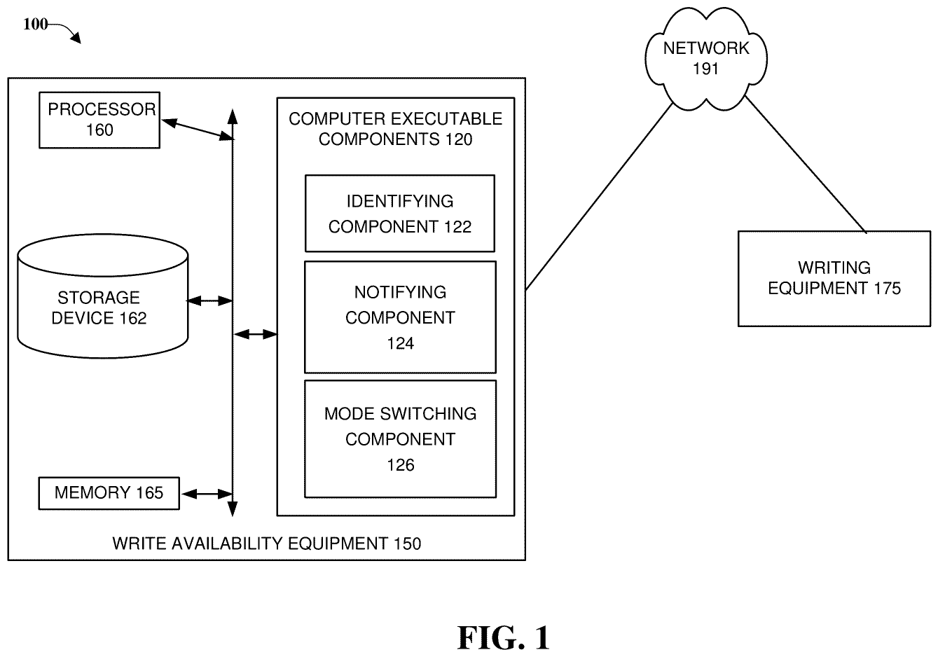

FIG. 1 is an architecture diagram of an example system 100 that can facilitate writer process isolation by designating memory blocks as write-reserved, in accordance with one or more embodiments. For purposes of brevity, description of like elements and/or processes employed in other embodiments is omitted. As depicted, system 100 includes write availability equipment 150 connected, via network 191, to writing equipment 175. As described herein, memory blocks may also be referenced as system memory, system memory blocks, disk blocks, and other variations of terms that reference storage locations usable by one or more embodiments.

As depicted, write availability equipment 150 can include memory 165 that can store one or more computer and/or machine readable, writable, and/or executable components 120 and/or instructions. In embodiments, write availability equipment 150 can further include processor 160. In one or more embodiments, computer executable components 120, when executed by processor 160, can facilitate performance of operations defined by the executable component(s) and/or instruction(s). Computer executable components 120 can include locking component 122, designating component 124, designation removing component 126, and other components described or suggested by different embodiments described herein, that can improve the operation of system 100. Write availability equipment 150 may further include storage device 162. In an example, storage device 162 may provide nonvolatile storage of data, data structures, computer executable instructions, and so forth.

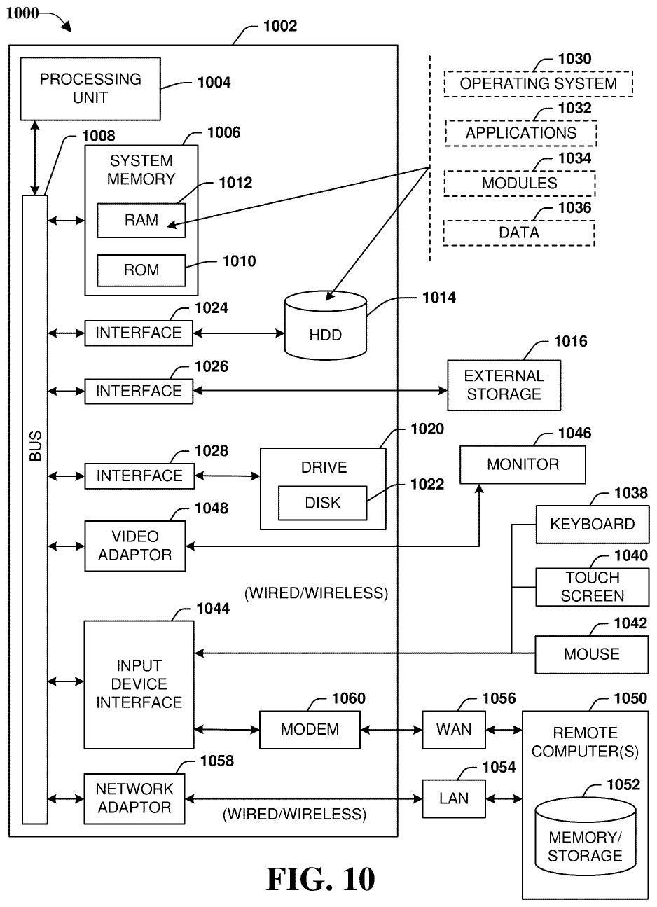

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

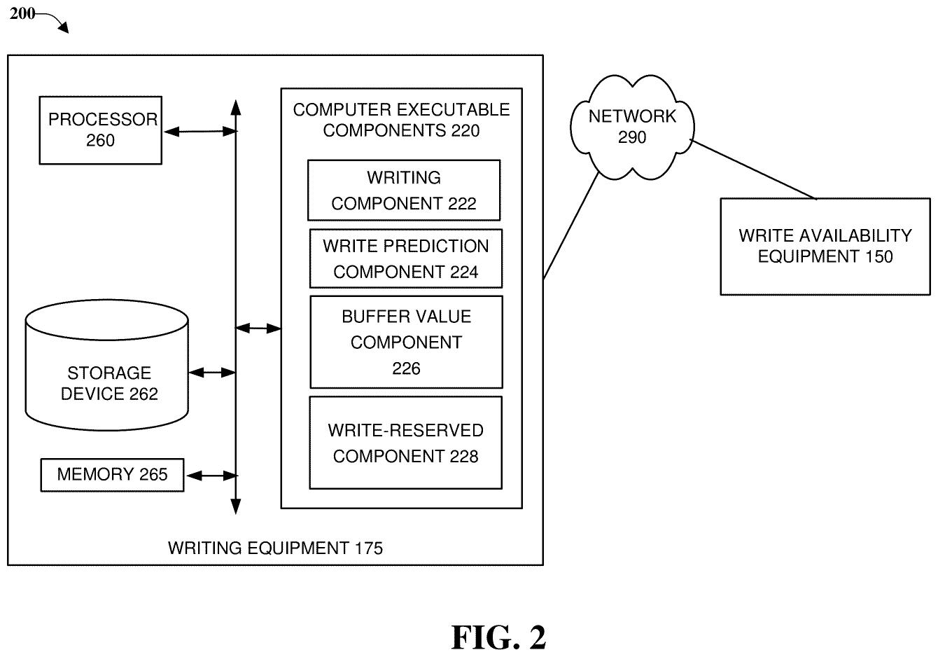

It should be noted that write availability equipment 150, writing equipment 175, and other devices discussed herein, can execute code instructions that may operate on servers or systems, remote data centers, or ‘on-box’ in individual client information handling systems, according to various embodiments described herein. In some embodiments, it is understood any or all implementations of one or more embodiments described herein can operate on a plurality of computers, collectively referred to as write availability equipment 150. For example, one or more of the functions of write availability equipment 150, and writing equipment 175, can all be implemented as separate subsystems running in the kernel of a computing device as well as operating on separate network equipment, e.g., as depicted in FIGS. 1 and 2.

FIG. 2 is an architecture diagram of an example system 200 that can facilitate writer process isolation by designating memory blocks as write-reserved, in accordance with one or more embodiments. For purposes of brevity, description of like elements and/or processes employed in other embodiments is omitted. As depicted, system 200 includes writing equipment 175 connected, via network 290, to write availability equipment 150. Writing equipment 175 includes processor 260, memory 265, storage device 262, and computer executable components 220.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include writing component 222, write prediction component 224, buffer value component 226, write-reserved component 228, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

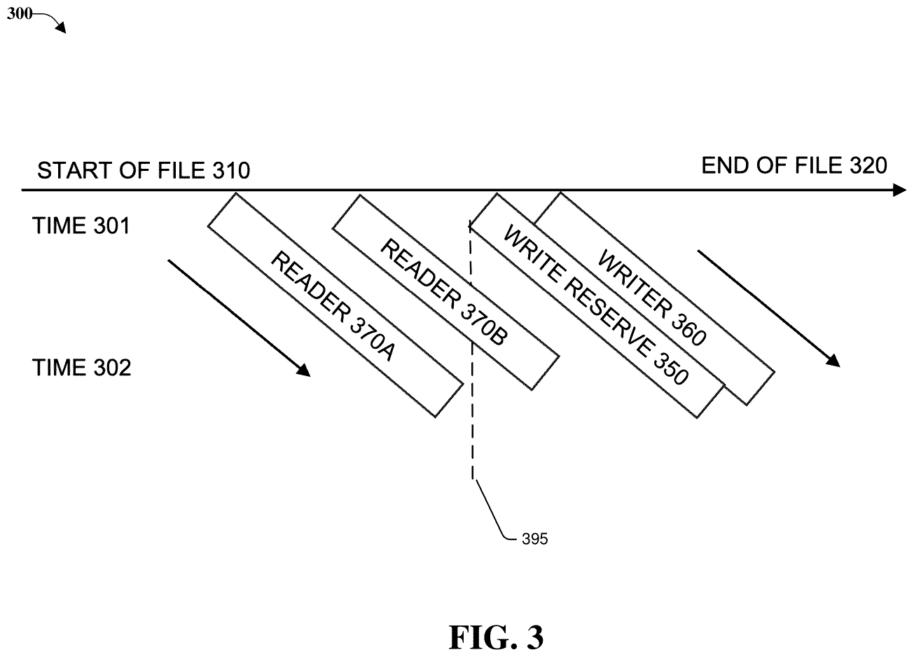

FIG. 3 includes a diagram that illustrates aspects of example system 300 that can facilitate writer process isolation by designating memory blocks as write-reserved, in accordance with one or more embodiments. For purposes of brevity, description of like elements and/or processes employed in other embodiments is omitted. System 300 includes a diagram with time 301-302 on the Y-axis and the length of a file being simultaneously written and read on the X-axis, e.g., start of file 310 to end of file 320. On the chart, readers 370A-B are reading the file and writer 360 is writing the file. Write-reserve 350 illustrates a portion of the file that is designated as a write-reserved portion of the file. As used herein, a writer may also be referenced as a writing process, and blocks designated as write reserve(d) may also be referenced as being designated write available.

In an example of system 300, at time 301, writer 360 may write, at a writing speed, memory block of a streamed file to a sequential memory block range of a system memory, and concurrent with the writing of the first memory block, readers 370A-B read the stream from a sequential memory block range of the system memory trailing the sequential memory block range of the writing process.

In some embodiments, in order to avoid the reader processes 370A-B interfering with the writer process 360, at time 301 and 302, a write reserve 350 block may be designated, where the reader processes are unable to read, e.g., obtain a non-exclusive read lock. In an example, in order to select the blocks to designate as write reserve 350, embodiments may predict, with threshold likelihood, that the writer process 360 is going to continue writing and extending end of file 320.

Based on the writer 360 process being predicted to continue writing the file, embodiments may determine the blocks of write reserve 360 by selecting a buffer value based on an estimated reading speed of the reading process in the reading of the stream. Based on this buffer value, the memory blocks of write reserve 350 may be designated by a buffer block size to the memory blocks between the memory blocks being written by writer 360 and the memory blocks being read by readers 370A-B. In an example shown, where multiple readers are reading the stream, one or more embodiments may select the reading process that is estimated to have the highest throughput.

Additional or alternative embodiments may continuously or at some selected interval, analyze the reading by the memory reading processes 370A-B, and based on a result of the analyzing, one or more embodiments may dynamically update the estimated speed of the reading process, and based on the updated estimated speed, embodiments may update, the buffer value. In some embodiments, the buffer value may be reduced if too large a gap has developed between the writing and reading processes, e.g., to avoid a potentially unacceptable amount of lag in the reading process. Conversely, as embodiments operate, the buffer value may be increased if the gap between writing and reading processes has been reduced past a threshold size, e.g., to avoid having the reading process either abruptly stop, based on no new part of the file being available, or having lock contention by the reader cause writer to be delayed. In one or more embodiments, the buffer value may be selected probabilistically, e.g., by estimating a likelihood that, at current reading and writing rates, the reading process will be in contention with the writing process during the writing of the stream. A buffer size may then be selected that reduces this probability below a threshold value.

In additional or alternative embodiments, instead of a number of memory blocks, the buffer value be a time delay determined by comparing a speed of the memory writing process to the estimated speed of the reading process, and the buffer value was selected based on the estimated speed of the reading process and the speed of the memory writing process. In additional or alternative embodiments, the buffer value may include a period of time for the write reserve 350 designation to remain after the writing by the memory writing process, e.g., at a selected time period, write reserve designation 350 is incrementally removed from memory blocks trailing the writing process.

In an example, when a reading process requests a read lock on memory blocks that are designated as write reserve 350, the system may communicate a signal indicating that the memory writing process continues to write to the portion of memory, e.g., the memory blocks are subject to an exclusive write lock. In an alternative approach, when a reading process requests a read lock on memory blocks that are designated as write reserve 350, the system may communicate a signal to the reading process that the memory requests is memory at an end of a file. In example implementation, by using existing lock access signals, this approach may facilitate reading processes not requiring changes to handle the additional states of memory blocks described herein.

Returning to FIG. 1, an example implementation of computer executable components 120 is now provided. In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of locking component 122, which can in some implementations can, based on a request from a memory writing process, lock a portion of memory with a first write lock that grants exclusive write access to the memory writing process. For example, in one or more embodiments, locking component 122 may, based on a request from writing equipment 175 for writer 360 (e.g., a memory writing process), lock a portion of memory with a first write lock that grants exclusive write access to the memory writing process.

In another example, memory 165 can store executable instructions that can facilitate generation of designating component 124, which in some implementations may, based on a releasing of the first write lock, designate the portion of memory with a write available designation, as available for acquisition of a second write lock that grants exclusive write access, and unavailable for access by a memory reading process. For example, in one or more embodiments, designating component 124 can, based on a releasing of the first write lock, designate the portion of memory with write reserve 350 designation (e.g., also referred to as a write available designation), as available for acquisition of a second write lock that grants exclusive write access, and unavailable for access by readers 370A-B.

In another example, memory 165 can store executable instructions that can facilitate generation of designation removing component 126, which in some implementations may, based on a condition being determined to be present, remove the write available designation. For example, in one or more embodiments, designation removing component 126 may, based on elapsing of a selected period of time (e.g., a condition being determined to be present), remove the write available designation. As illustrated in FIG. 3, point 395 is an example of a memory block in the file where the write-reserve 350 designation was removed between time 301 and 302, e.g., reader 370B is able to read from this point 395 at the time illustrated.

Returning to FIG. 2, an example implementation of computer executable components 220 is now provided. In an example implementation of writing equipment 175, memory 265 can store executable instructions that can facilitate generation of writing component 222, which in some implementations, may write, at a writing speed, a first memory block of a stream to a first sequential memory block range of a system memory, and concurrent with the writing of the first memory block, a reading process reads the stream from a second sequential memory block range of the system memory trailing the first sequential memory block range. For example, one or more embodiments, writing component 222 (e.g., writer 360) may write, at a writing speed, a first memory block of a stream to a first sequential memory block range of a system memory, and concurrent with the writing of the first memory block, readers 370A-B read the stream from a second sequential memory block range of the system memory trailing the first sequential memory block range.

In an example implementation of writing equipment 175, memory 265 can further store executable instructions that can facilitate generation of write prediction component 224, which in some implementations, may predict, with threshold likelihood, that an additional memory block will be written, resulting in a prediction. For example, in one or more embodiments, write prediction component 224 may predict, with threshold likelihood, that writer 360 will continue adding to the file.

In an example implementation of writing equipment 175, memory 265 can further store executable instructions that can facilitate generation of buffer value component 226, which in some implementations, may select a buffer value, with the buffer value being based on an estimated reading speed of the reading process in the reading of the stream. For example, in one or more embodiments, buffer value component 226 may select a buffer value for the designation of write reserve 350, with the buffer value being based on an estimated throughput of reader 370B, e.g., the reading process with the highest throughput.

In an example implementation of writing equipment 175, memory 265 can further store executable instructions that can facilitate generation of write-reserved component 228, which in some implementations, may, based on the buffer value and the prediction, apply a write-reserved designation of a buffer block size to the third sequential memory block range of the system memory. For example, in one or more embodiments, write-reserved component 228 may, based on the buffer value and the prediction, designate write-reserve 350 of a buffer block size to the third sequential memory block range of the system memory.

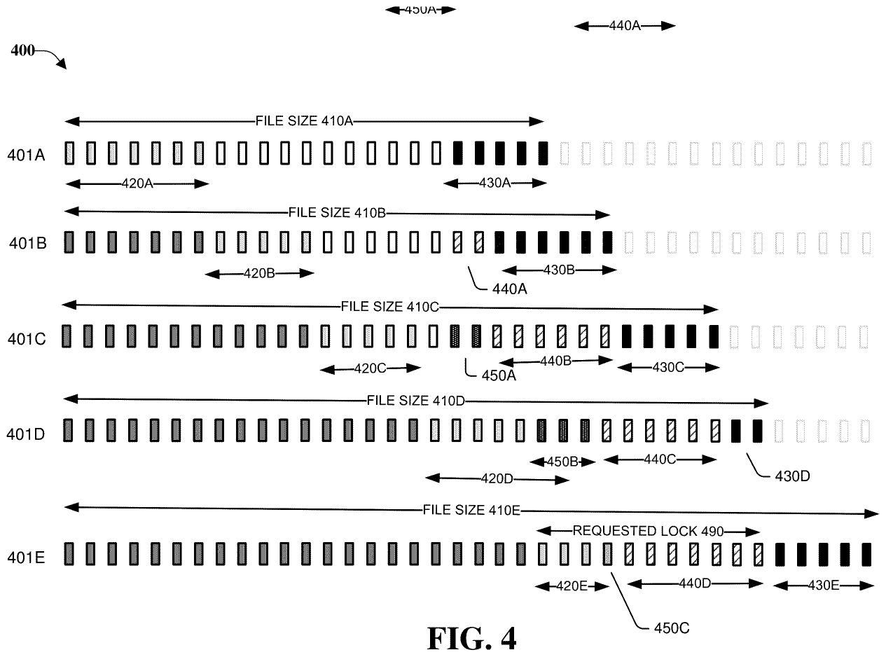

FIG. 4 includes a diagram that illustrates aspects of example system 400 that can facilitate writer process isolation by designating memory blocks as write-reserved, in accordance with one or more embodiments. For purposes of brevity, description of like elements and/or processes employed in other embodiments is omitted. For blocks of a file over times 401A-E, FIG. 4 illustrates memory blocks that are locked, written, read, designated as write-reserved, subject to having the designation of being write-reserved removed. In this example, the example memory blocks represent blocks of a stream being written and read simultaneously, with a file size that grows with the stream from 410A-E. Arrows 420A-E represent areas where a non-exclusive read lock has been granted to a reader process, arrows 430A-E represent memory blocks subject to an exclusive write-lock for a writing process to write the file. Arrows 440A-D represent memory blocks that have been designated as write-reserved and arrows 450A-C represent memory blocks that were write-reserved, but were released from this designation.

Time 401A begins after blocks of the file have been written by a writing process, e.g., with file size 410A spanning 23 blocks. Of these blocks, five blocks are subject to an exclusive write-lock 430A, seven blocks are subject to a non-exclusive read-lock, and eleven blocks between these locked regions have been written, and are available for locking, e.g., either to be rewritten, or read. Time 401A illustrates an example operation without application of one or more embodiments that utilize write-reserved designations to regulate read-locking.

Time 401B continues with the blocks subject to exclusive write-lock 430A having been written to, and with six blocks being subject to exclusive write lock 430B. In one or more embodiments, based on a releasing of exclusive write-lock 430A, two data blocks are designated as write-reserved 440A. In one or more embodiments, after the designating of the blocks of memory as write-reserved 440A, no writes to the portion of memory may occur, e.g., read locks are not permitted to be placed on these memory blocks. In one or more embodiments, the number of blocks that were selected to be write-reserved 440A may be based on an estimated speed of the reading process as compared to the writing process.

As may be noted from FIG. 4, at time 401A, eleven memory blocks are between the end of write lock 430A and the beginning of read lock 420A, and at 401B, the number of memory blocks between the end of write lock 430B and the beginning of read lock 420B has been reduced to six. In this example, this may indicate that the reading process may overtake the writing process and cause lock contention that may interfere with the writing process. In an embodiment, the number of memory blocks that is selected to be designated as write reserved 440A may be based on this type of analysis of the comparative speeds of the reading and writing processes.

At 401C, it is noted that the write-reserved designation of the 440A memory blocks has been removed, and the number of write-reserved 440B memory blocks has been increased, e.g., by one or more embodiments analyzing the relative speeds of the reading process and the writing process. As depicted at 401C, non-exclusive read lock 420C has been granted, and the number of memory blocks between the end of write lock 430C and the beginning of read lock 420C has increased to nine.

At 401D, it is noted that the exclusive write-lock 430D has reduced to two memory blocks, e.g., based on the writing process slowing down for different reasons. In this example, read lock 420D has been requested and granted both for memory blocks that were free and for memory blocks that were write-reserved, but were released from this designation at 450B. As depicted at 401D, non-exclusive read lock 420D has been granted, and the number of memory blocks between the end of write lock 430D and the beginning of read lock 420D has been maintained at nine.

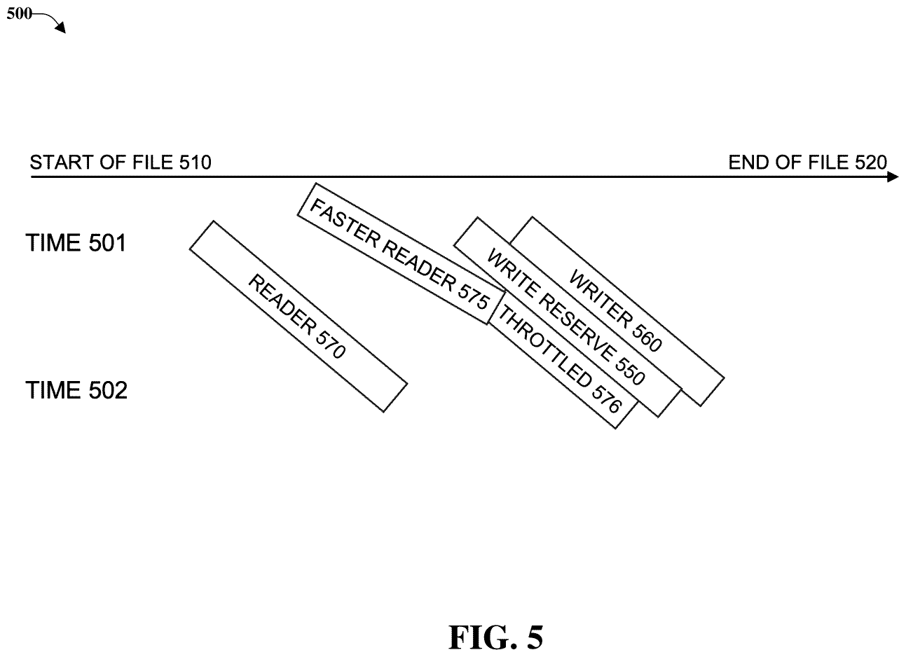

At 401E, the reading process throughput increases, and the reading process requests a non-exclusive read lock 490 on blocks that have been granted a designation of write-reserved 440D memory blocks. In one or more embodiments, based on the request 490 for the non-exclusive read lock being requested for write-reserved 440D memory blocks, the request is rejected, and non-exclusive read lock 420E is granted, e.g., for fewer memory blocks than were granted to non-exclusive read lock 420E. In one or more embodiments discussed with FIG. 5 below, this illustrates the throttling that embodiments may use when a reading process seeks to read memory blocks that are too close to memory blocks being written 430E.

FIG. 5 includes a diagram that illustrates aspects of example system 500 that can facilitate writer process isolation by designating memory blocks as write-reserved, in accordance with one or more embodiments. For purposes of brevity, description of like elements and/or processes employed in other embodiments is omitted. System 500 includes a diagram with time 501-502 on the Y-axis and the length of a file being simultaneously written and read on the X-axis, e.g., start of file 510 to end of file 520. On the chart, reader 570 and faster reader 575 are reading the file and writer 560 is writing the file. Write-reserve 550 illustrates a portion of the file that is designated as a write-reserve portion of the file. As described further below, throttled 576 represents faster reader 575 being throttled for seeking to read parts of the file that were designated as write reserved 550.

In the example chart of FIG. 5, the slope of the blocks representing reader 570 and faster reader 575 represent the throughput of the respective reading processes, e.g., the shallower gradient of faster reader 575 at time 501 illustrates the higher throughput of this process as compared to reader 570. At time 502, as faster reader 575 approaches writer 560, different approaches may be utilized to throttle faster reader 575, e.g., increasing the slope to throttled 576. As noted above, signals may be sent to faster reader that the end of file 520 has been reached, or that writer 560 has an exclusive write lock on the requested write reserved 550 memory blocks.

In one or more embodiments, an additional benefit besides reducing contention may be realized, based on write reserved 550 memory blocks being available for exclusive write locking by other writer processes. In this way, having write reserve be locked for reading processes and unlocked for writing processes, embodiments may facilitate more efficient approaches to sharing the writing of files/streams by different processes.

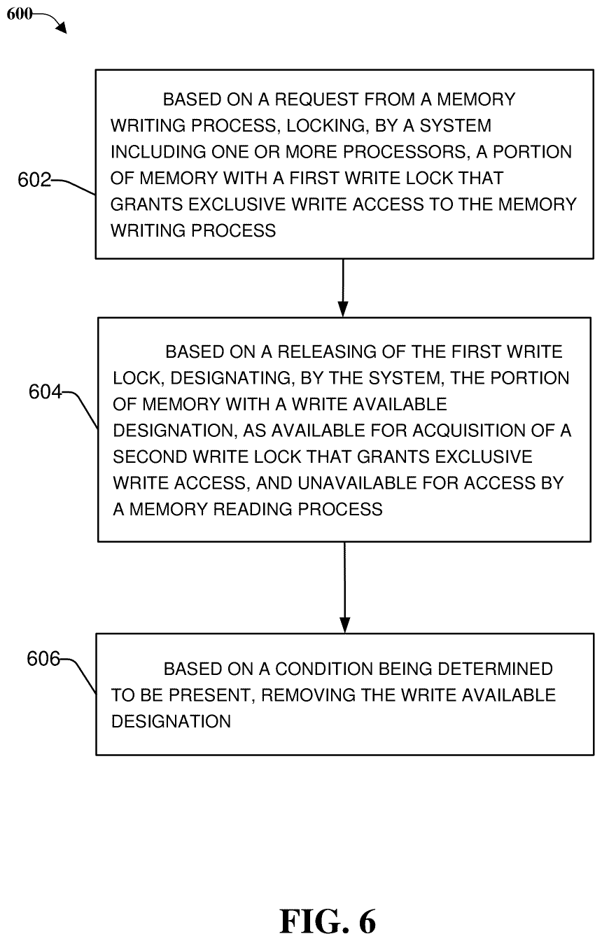

FIG. 6 depicts a flow diagram representing example operations of an example method 600 that can facilitate managing system services based on detection of node maintenance events, in accordance with one or more embodiments. For purposes of brevity, description of like elements and/or processes employed in other embodiments is omitted.

In some examples, one or more embodiments of method 600 can be implemented by locking component 122, designating component 124, designation removing component 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, locking component 122 of write availability equipment 150 can, based on a request from a memory writing process, lock a portion of memory with a first write lock that grants exclusive write access to the memory writing process. At 604 of method 600, designating component 124 can, based on a releasing of the first write lock, designate the portion of memory with a write available designation, as available for acquisition of a second write lock that grants exclusive write access, and unavailable for access by a memory reading process. At 606 of method 600, designation removing component 126 can, based on a condition being determined to be present, remove the write available designation.

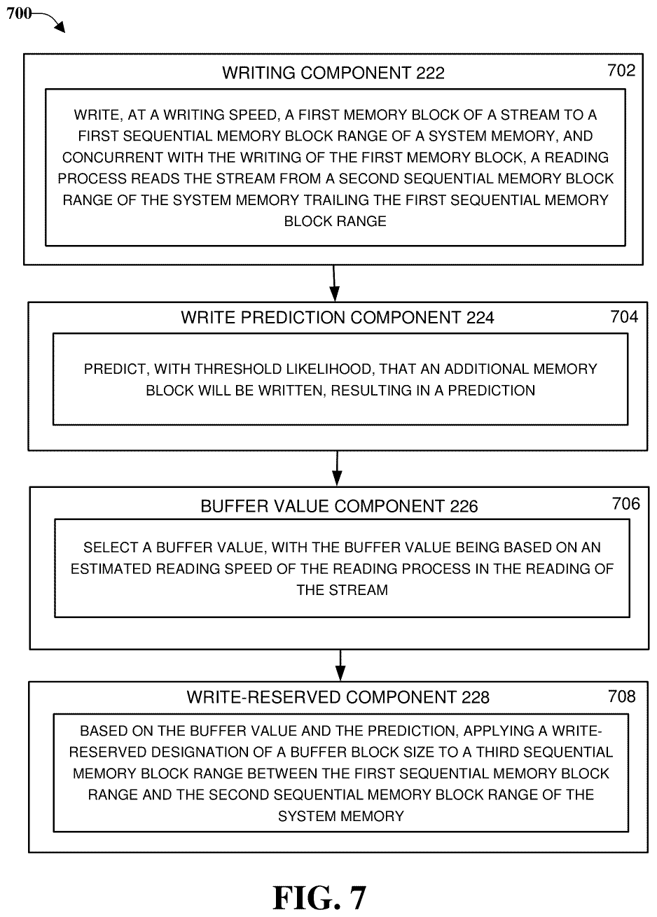

FIG. 7 depicts an example system 700 that can facilitate writer process isolation by designating memory blocks as write-reserved, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including writing component 222, write prediction component 224, buffer value component 226,, write-reserved component 228, and other components that can be used to implement aspects of system 700, as described herein, in accordance with one or more embodiments.

At 702 of FIG. 7, writing component 222 can write, at a writing speed, a first memory block of a stream to a first sequential memory block range of a system memory, and concurrent with the writing of the first memory block, a reading process reads the stream from a second sequential memory block range of the system memory trailing the first sequential memory block range. At 704 of FIG. 7, write prediction component 224 can predict, with threshold likelihood, that an additional memory block will be written, resulting in a prediction. At 706 of FIG. 7, buffer value component 226 can select a buffer value, with the buffer value being based on an estimated reading speed of the reading process in the reading of the stream. At 708 of FIG. 7, write-reserved component 228 can, based on the buffer value and the prediction, applying a write-reserved designation of a buffer block size to a third sequential memory block range between the first sequential memory block range and the second sequential memory block range of the system memory.

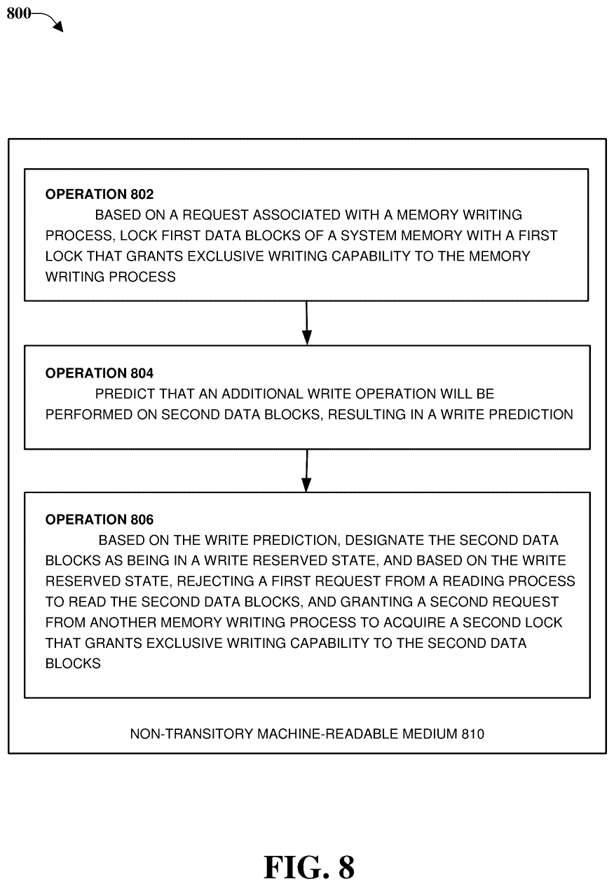

FIG. 8 depicts an example 800 non-transitory machine-readable medium 810 that can include executable instructions that, when executed by a processor of a system, can facilitate writer process isolation by designating memory blocks as write-reserved, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can, based on a request associated with a memory writing process, locking first data blocks of a system memory with a first lock that grants exclusive writing capability to the memory writing process. The operations may further include operation 804 which can predict that an additional write operation will be performed on second data blocks, resulting in a write prediction. The operations may further include operation 806 which can, based on the write prediction, designate the second data blocks as being in a write reserved state, and based on the write reserved state, rejecting a first request from a reading process to read the second data blocks, and granting a second request from another memory writing process to acquire a second lock that grants exclusive writing capability to the second data blocks.

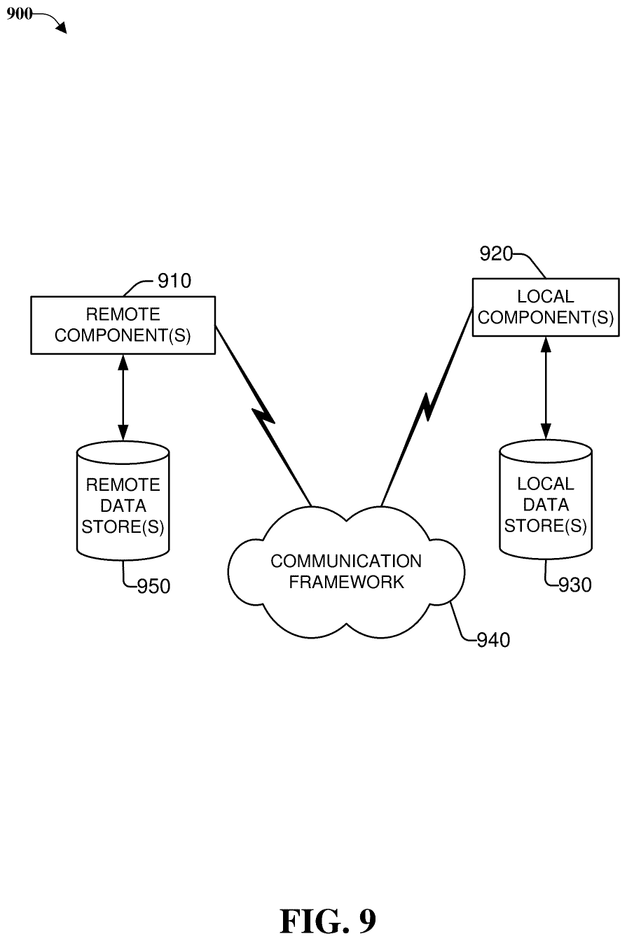

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD...), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising,
based on a request from a memory writing process, locking, by a system comprising one or more processors, a portion of memory with a first write lock that grants exclusive write access to the memory writing process;
based on a releasing of the first write lock, designating, by the system, the portion of memory with a write available designation, as:
available for acquisition of a second write lock that grants exclusive write access, and
unavailable for access by a memory reading process; and
based on a condition being determined to be present, removing, by the system, the write available designation.

2. The method of claim 1, wherein, after the designating of the portion of memory with the write available designation, no writes to the portion of memory occur, and wherein, after the removal of the write available designation, the memory reading process reads the portion of memory.

3. The method of claim 1, further comprising:
based on an estimated speed determined to be applicable to the memory writing process, selecting, by the system, a buffer value corresponding to usage of a buffer to use for the memory reading process, wherein the condition comprises the buffer value.

4. The method of claim 3, further comprising:
analyzing, by the system, reading by the memory reading process and writing by the memory writing process; and
based on a result of the analyzing, updating, by the system, the buffer value.

5. The method of claim 3, wherein the buffer value comprises a time delay determined by comparing the estimated speed of the memory writing process to an estimated speed of the memory reading process.

6. The method of claim 3, wherein the buffer value comprises an amount of memory blocks to remain unavailable for reading by the memory reading process after writing by the memory writing process.

7. The method of claim 3, wherein the memory writing process comprises a stream writing process that writes a stream to the memory, and wherein the memory reading process reads the stream sequentially.

8. The method of claim 7, wherein the buffer value was selected based on a likelihood that the memory reading process is going to be in contention with the stream writing process during the writing of the stream.

9. The method of claim 8, wherein the contention comprises a pausing of the memory reading process based on the memory reading process seeking to read a next block after a last block written by the stream writing process.

10. The method of claim 1, further comprising:
based on the designating of the portion of memory as write available, communicating, by the system to the memory reading process, a signal indicating that the memory writing process continues to write to the portion of memory, wherein the portion of memory is unavailable for access by the memory reading process in response to communicating the signal.

11. The method of claim 1, wherein the portion of memory is unavailable for access by the memory reading process based on the memory with the write available designation appearing to the memory reading process as memory at an end of a file.

12. The method of claim 1, wherein the portion of memory is unavailable for access by the memory reading process is based on the portion of memory with the write available designation appearing to the memory reading process as memory where exclusive write access has been granted.

13. A computing system, comprising:
at least one memory that stores computer executable instructions; and
at least one processor configured to process the computer executable instructions that, when executed by the at least one processor, facilitate performance of operations, comprising:
writing, at a writing speed, a first memory block of a stream to a first sequential memory block range of a system memory, wherein concurrent with the writing of the first memory block, a reading process reads the stream from a second sequential memory block range of the system memory trailing the first sequential memory block range,
predicting, with threshold likelihood, that an additional memory block will be written, resulting in a prediction,
selecting a buffer value, wherein the buffer value is based on an estimated reading speed of the reading process in the reading of the stream, and
based on the buffer value and the prediction, applying a write-reserved designation of a buffer block size to a third sequential memory block range between the first sequential memory block range and the second sequential memory block range of the system memory.

14. The computing system of claim 13, wherein the write-reserved designation allows the system to acquire an exclusive write lock to the third sequential memory block range, while preventing any reading of the third sequential memory block range.

15. The computing system of claim 14, wherein the write-reserved designation further allows other writing processes to acquire the exclusive write lock, when available.

16. The computing system of claim 13, wherein the buffer value was selected to reduce a likelihood that the reading process is going to contend with the writing of the stream.

17. The computing system of claim 13, wherein an exclusive write lock was granted to the system for usage with writing to the first sequential memory block range.

18. The computing system of claim 13, wherein the operations further comprise:
after a period of time passes without an exclusive write lock being placed on a block having the write-reserved designation, removing, by the system, the write-reserved designation from the block having the write-reserved designation.

19. A non-transitory machine-readable medium comprising executable instructions that, when executed by at least one processor, facilitate performance of operations, the operations comprising:
based on a request associated with a memory writing process, locking first data blocks of a system memory with a first lock that grants exclusive writing capability to the memory writing process;
based on releasing the first lock, predicting that an additional write operation will be performed on second data blocks, resulting in a write prediction;
based on the write prediction, designating the second data blocks as being in a write reserved state; and
based on the write reserved state:
rejecting a first request from a reading process to read the second data blocks, and
granting a second request from another memory writing process to acquire a second lock that grants exclusive writing capability to the second data blocks.

20. The non-transitory machine-readable medium of claim 19, wherein the operations further comprise, after a duration without a write operation performed on the second data blocks, designating the second data blocks as not being in the write reserved state.
